(19) United States
(12) Patent Application Publication
(10) Pub. No.: US 2025/0367695 A1
(43) Pub. Date: Dec. 4, 2025

(54) DEVICES, SYSTEMS, AND METHODS FOR MACHINERY MONITORING AND REPORTING

(71) Applicant: Ag Leader Technology, Ames, IA (US)

(72) Inventors: David Wilson, Prairie City, IA (US); Joe Holoubek, Ames, IA (US); Mike Myers, Ames, IA (US)

(21) Appl. No.: 19/226,004

(22) Filed: Jun. 2, 2025

Related U.S. Application Data
(60) Provisional application No. 63/654,634, filed on May 31, 2024.

(51) Int. Cl. B05B 12/00; A01C 23/02; A01C 23/04; G06V 20/52

(52) U.S. Cl. CPC B05B 12/004; A01C 23/023; A01C 23/047; G06V 20/52

(57) ABSTRACT

The disclosed system, and related devices and methods, relate to monitoring equipment, such as agricultural equipment, to ensure efficient, effective, and reliable operation. The system, in several implementations, may detect leaks, plugged lines, poor fertilizer application, and maintenance issues, among other applications that would be clear to those skilled in the art.

### CROSS-REFERENCE TO RELATED APPLICATION(S)

This application claims the benefit under 35 U.S.C. § 119(e) to U.S. Provisional Application 63/654,634, filed May 31, 2024, and entitled Equipment Thermal Monitoring System and Associated Methods and Devices, which is hereby incorporated herein by reference in its entirety for all purposes.

### TECHNICAL FIELD

The disclosure relates to monitoring systems for use on agricultural equipment.

### BACKGROUND

Equipment, including agricultural equipment, may experience leaks, breaks, and wear that can decrease efficiency and/or effectiveness of the equipment or may completely disable the equipment. Additionally, inefficient operation of agricultural equipment can lead to wasted material. As such, inefficient operating conditions also need to be quickly identified and remedied.

### BRIEF SUMMARY

Disclosed herein are various implementations of a monitoring system operating at least in part by thermal imaging, along with related devices and methods for monitoring agricultural equipment. In some implementations, the system is configured to detect thermal changes in the parts, sections, and/or products of agricultural equipment. The system may identify and log differences in measured temperature from temperatures expected during normal operation. Such differences when detected by the system may be indicative of various failures and lead to warnings, corrective actions, and the like.

In Example 1, an agricultural equipment monitoring system, comprising a thermal imaging camera oriented to monitor some or all of the agricultural equipment and a computer in electronic communication with the thermal imaging camera, wherein the thermal imaging camera and computer detect changes in temperature.

Example 2 relates to the system of any of Examples 1 and 3-10, further comprising a notification system configured to notify a user of an adverse condition, wherein the notification system is in electronic communication with the computer.

Example 3 relates to the system of any of Examples 1-2 and 4-10, wherein the presence of an adverse condition is determined by a change in temperature.

Example 4 relates to the system of any of Examples 1-3 and 5-10, wherein the agricultural equipment comprises one or more spray nozzles.

Example 5 relates to the system of any of Examples 1-4 and 6-10, wherein the adverse condition is a clog indicated by a lack of one or more spray cones emanating from the one or more spray nozzles.

Example 6 relates to the system of any of Examples 1-5 and 7-10, wherein the adverse condition is a leak indicated by a cold environment around a hose leading to the one or more spray nozzles.

Example 7 relates to the system of any of Examples 1-6 and 8-10, wherein the agricultural equipment comprises one or more injection tubes.

Example 8 relates to the system of any of Examples 1-7 and 9-10, wherein the adverse condition is vaporization of an injected fluid indicated by a cold environment trailing the one or more injection tubes.

Example 9 relates to the system of any of Examples 1-8 and 10, wherein the adverse condition is a leak indicated by a cold environment around a hose leading to the one or more injection tubes.

Example 10. relates to the system of any of Examples 1-9, wherein the adverse condition is a maintenance issue indicated by a hot environment around a component.

In Example 11, a method of identifying an adverse condition in agricultural equipment, comprising measuring temperatures in a field of view with a thermal imaging camera, determining if the measured temperatures indicate an adverse condition, and notifying a user of the adverse condition.

Example 12 relates to the method of any of claims 11 and 13-19, wherein one or more spray nozzles and hoses are in the field of view and the hoses connect the one or more spray nozzles to a sprayer pump.

Example 13 relates to the method of any of claims 11-12 and 14-19, wherein the adverse condition is a clog indicated by the lack of one or more spray cones emanating from the one or more spray nozzles.

Example 14 relates to the method of any of claims 11-13 and 15-19, wherein the adverse condition is a leak indicated by a cold environment around a hose leading to the one or more spray nozzles.

Example 15 relates to the method of any of claims 11-14 and 16-19, wherein one or more injection tubes and hoses are in the field of view and the hoses connect the one or more spray nozzles to a sprayer pump.

Example 16 relates to the method of any of claims 11-15 and 17-19, wherein the adverse condition is vaporization of an injected fluid indicated by a cold environment trailing the one or more injection tubes.

Example 17 relates to the method of any of claims 11-16 and 18-19, wherein the adverse condition is a leak indicated by a cold environment around a hose leading to the one or more injection tubes.

Example 18 relates to the method of any of claims 11-17 and 19, wherein the adverse condition is a maintenance issue indicated by a hot environment around a component.

Example 19 relates to the method of any of claims 11-18, wherein the adverse condition is a maintenance issue indicated by a hot environment around a component.

In Example 20, an equipment monitoring system, comprising a thermal imaging camera configured to measure temperatures, a computer in electronic communication with the thermal imaging camera and configured to detect changes in temperature, and a notification system in electronic communication with the computer, wherein the thermal imaging camera transmits the temperatures to the computer and the computer instructs the notification system to notify a user if a change in temperature occurs.

The system may include one or more computers or computing devices that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a rear view of the trench visualization system fitted to an agricultural vehicle, according to one implementation.

FIG. 1B is a diagram of the operations system of the trench visualization system, according to one implementation.

FIG. 2 is a perspective view of an agricultural sprayer, according to one implementation.

FIG. 3 is a diagram of the system in use with an agricultural sprayer, according to one implementation.

FIG. 4 is a diagram of the system in use with an agricultural sprayer with a clogged spray nozzle, according to one implementation.

FIG. 5 is a diagram of the system in use with an agricultural sprayer with a leak, according to one implementation.

FIG. 6 is a thermal image taken by the system of an agricultural sprayer boom, according to one implementation.

FIG. 7 is a diagram of the system in use with a fertilizer applicator, according to one implementation.

FIG. 8 is an image of a fertilizer applicator with fertilizer vaporizing from the ground, according to one implementation.

FIG. 9A is a thermal image taken by the system of a fertilizer applicator with little or no fertilizer vaporization, according to one implementation.

FIG. 9B is a thermal image taken by the system of a fertilizer applicator with some fertilizer vaporization, according to one implementation.

FIG. 9C is a thermal image taken by the system of a fertilizer applicator with substantial fertilizer vaporization, according to one implementation.

FIG. 10 is a diagram of the system in use with a header of a combine harvester, according to one implementation.

FIG. 11 in a thermal image showing an installation location and field of view of a thermal imaging camera, according to one implementation.

FIG. 12 is a method diagram showing how the system may categorize the measured information, according to one implementation.

### DETAILED DESCRIPTION

Disclosed herein are various implementations of an equipment monitoring system. In the various implementations, the monitoring system includes devices and systems for thermal imaging, along with other related devices and systems. In various implementations, the monitoring system may be used with agricultural equipment, such as sprayers or combine harvesters, but various other applications are possible and would be understood in light of this disclosure.

In various implementations, the system is configured to monitor a item of agricultural equipment or section thereof with one or more thermal imaging devices. The system may then record the detected temperatures along the equipment, including at particular sections indicative or certain parts of interest. The system may then compare the detected temperature to an expected or baseline temperature to determine if there has been a change in temperature or deviation from the expected or baseline temperature. If a change in temperature/deviation is greater than a threshold value the change may be recorded and an operator alerted. In certain further implementations, if the change in temperature/deviation is indicative of a particular issues (e.g. a rise in temperature indicating increased friction or a decrease in temperature indicating a clogged nozzle) the system may automatically or semi-automatically take preventative or corrective action (e.g. stopping the equipment or flushing a line). In certain implementations, the thermal image may be displayed to a user/operator in real-time or near real-time and/or recorded for future viewing/analysis.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. Patent Application 63/654,634, filed May 31, 2024, entitled “Equipment Thermal Monitoring System and Associated Methods and Devices,” U.S. Patent Application 63/667,546, filed Jul. 3, 2024, entitled “Cover for Port Openings,” U.S. Patent Application 63/667,530, filed Jul. 3, 2024, entitled “Agricultural Seed Meters and Related Devices, Systems and Methods,” U.S. Patent Application 63/685,000, filed Aug. 20, 2024, entitled “Crop Sensor Wands and Related Devices, Systems, and Methods,” U.S. Patent Application 63/682,229, filed Aug. 12, 2024, entitled “Integrated Crop Sensor and GPS Steering Systems and Related Devices and Methods,” U.S. Patent Application 63/710,492, filed Oct. 22, 2024, entitled “Crop Sensors and Related Devices, Systems, and Methods,” U.S. Patent Application 63/710,641, filed Oct. 23, 2024, entitled “Agricultural Sprayer Boom Flush, Chemical Detection and Chemical Concentration Detection,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” each of which is incorporated herein by reference.

Throughout this disclosure, several implementations and applications will be discussed, which address an undesirable situation or failure related to the operation of equipment, often agricultural equipment. In general terms, these undesirable situations, may include but are not limited to leaks, clogs, inefficient applications, machine wear or friction, and the like. These undesirable situations are collectively referred to herein as adverse conditions. This disclosure offers solutions to prevent and/or remedy these adverse conditions.

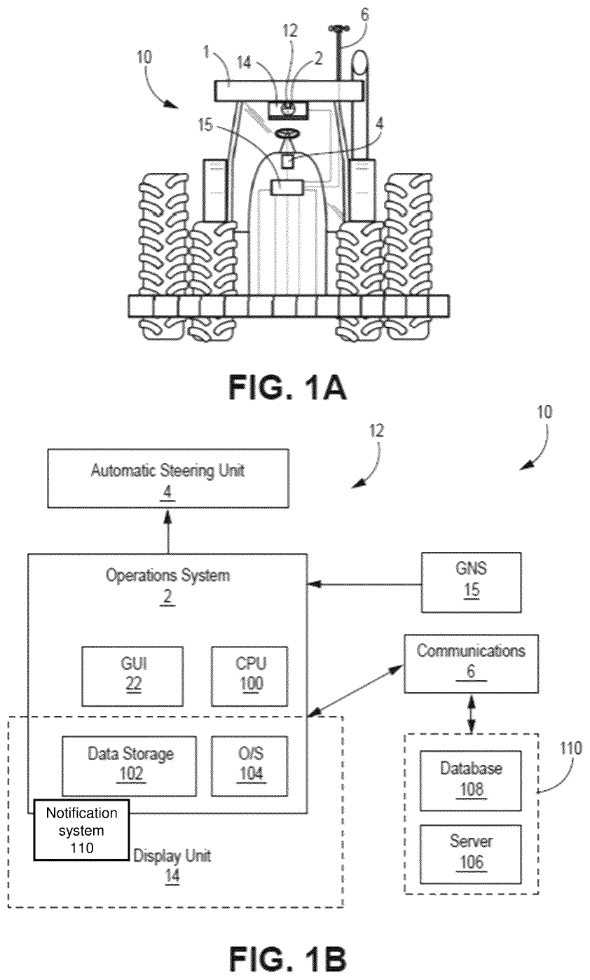

Turning to the drawings in greater detail, FIGS. 1A-1B depict exemplary implementations of the monitoring system 10 components fitted to an agricultural vehicle 1. In various implementations, the agricultural vehicle 1 may be a tractor 1, semi, grain cart, harvester, or the like, optionally having an implement such as a planter, sprayer, or the like, as would be understood. It is understood that a variety of vehicles 1 and implements can be utilized in various implementations. It is further understood that the components depicted in FIGS. 1A-1B are optional, and can be utilized or omitted in the various implementations, and that certain additional components may be required to effectuate the various processes and systems described herein. Such additional components may include hardware, software, firmware, and other electronic components that would be known and appreciated by those of skill in the art.

As shown in FIG. 1A, the monitoring system 10 has an operations system 2 that comprises or is configured to be operationally integrated with a steering unit 4, such as SteerCommand®, and an optional communications component 6. The system 10 is operationally integrated with at least one in-cab display 14, such as an InCommand® display 14, or other suitable display 14 understood in the art. It is appreciated that certain of these displays 14 feature touchscreens, while others are equipped with necessary components for interaction with the various prompts and adjustments discussed herein, such as via a keyboard or other interface.

In various implementations, the system 10 is also operationally integrated with a GNSS or GPS unit 15, such as a GPS 7500, such that the system 10 is configured to input positional data for use in defining boundaries, locating the tractor 1, plotting guidance, identifying locations of adverse conditions/events, and the like, as would be readily appreciated.

As shown in FIG. 1B, in various implementations, the operations system 2 is optionally in operational communication with the automatic steering unit 4 or controller 4, the communications component 6, and/or GNSS 15. In certain of these implementations, the operations system 2 is housed in the display 14, though the various components described herein can be housed elsewhere, as would be readily appreciated.

As shown in FIG. 1B, the operations system 2 further has one or more optional processing and computing components, such as a CPU/processor 100, data storage 102, operating system 104, and other computing components necessary for implementing the various technologies disclosed herein. It is appreciated that the various optional system 10 components are in operational communication with one another via wired or wireless connections and are configured to perform the processes and execute the commands described herein.

In certain implementations, like that of FIG. 1B, the communications component 6 is configured for the sending and receiving of data for cloud 110 storage and processing, such as to a remote server 106, database 108, and/or other cloud computing components readily understood in the art. Such connections by the communications component 6 can be made wirelessly via understood internet and/or cellular technologies such as Bluetooth, WiFi, LTE, 3G, 4G, or 5G connections and the like. It is understood that in certain implementations, the communications component 6 and/or cloud 110 components comprise encryption or other data privacy components such as hardware, software, and/or firmware security aspects. In various implementations, the operator or enterprise manager or other third parties are able to receive notifications such as adjustment prompts and confirmation screens on their mobile devices, and in certain implementations can review the imaging and related data and make adjustments via their mobile phones or other remote devices.

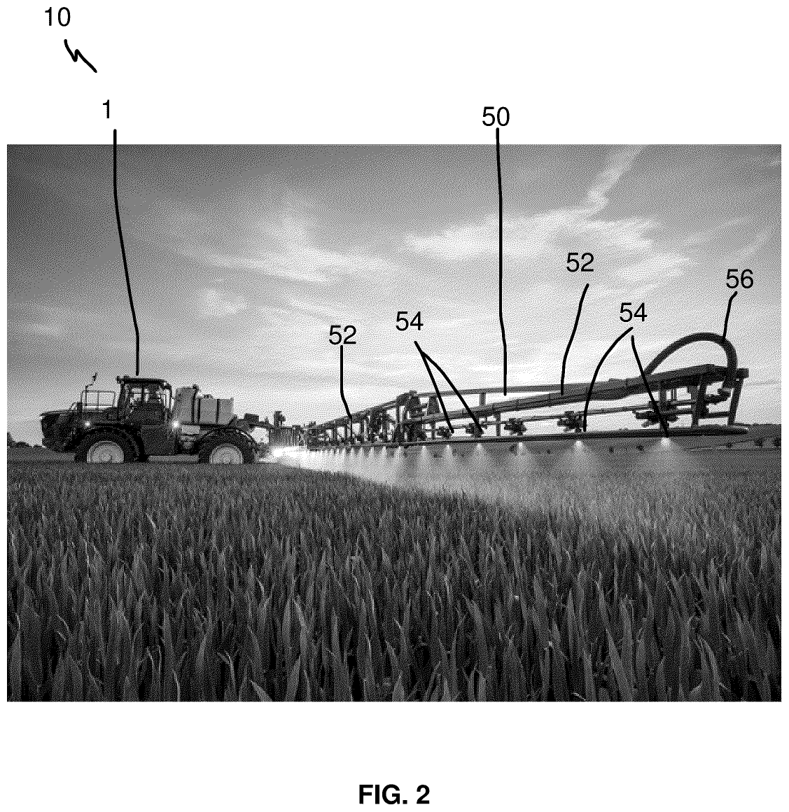

FIG. 2 shows a typical agricultural sprayer 50, which is typically mounted behind a tractor 1. The sprayer 50 may have one or more booms 52 that support one or more spray nozzles 54. The spray nozzles 54 are connected to one or more hoses 56 that fluidically connect with one or more sprayer pumps. Fluid, such as liquid fertilizer, may be pumped from the sprayer pumps through the hoses 56 and through the spray nozzles 54, where it is atomized into spray cones 58. As would be understood, the atomization of a fluid may cause a decrease in the temperature of the fluid through evaporative cooling and similar phenomena. Various additional configurations for sprayers 50 are possible including additional or alternative components, which would be understood and appreciated by those of skill in the art.

In various implementations, the fluid may be liquid fertilizer such as anhydrous ammonia (NH₃), a liquid pesticide/herbicide, irrigation water, or others as would be understood by those of skill in the art.

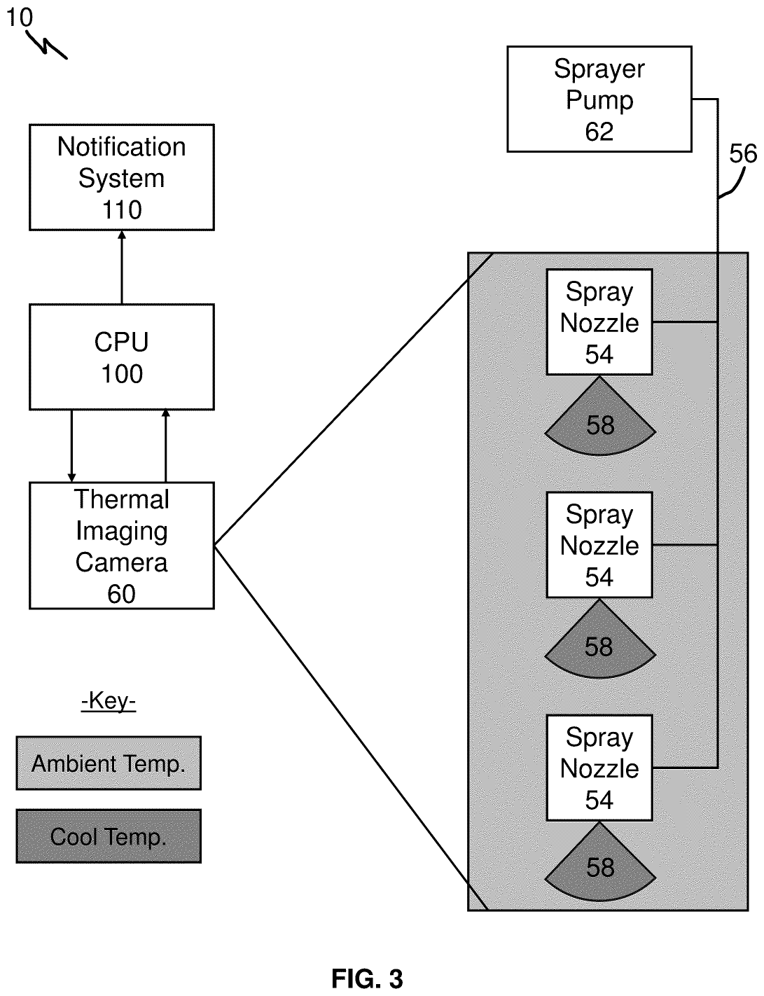

FIG. 3 shows a diagram of one implementation of the system 10 arranged to monitor the spray cones 58 of a sprayer 50. The system 10, in various implementations, may have a thermal imaging camera 60 in electronic communication with a computer/CPU 100. The thermal imaging camera 60 may be able to detect and visualize the temperature of surfaces and areas within its field of view, optionally through the measurement of intensity of electromagnetic radiation, such as infrared radiation, absorbed by the thermal imaging camera 60 that had originated from the corresponding surface, as would be generally understood.

In some implementations, the thermal imaging camera 60 may output an array or matrix of temperature information to the computer 100. In other implementations, the thermal imaging camera 60 may output an array or matrix of raw data, such as light wavelengths, intensities, and other characteristics directly measured by the thermal imaging camera 60.

In various implementations, the system 10 may segment the thermal images into discrete sections, where each discrete section is indicative of a certain part or area of the observed equipment. In the example of a sprayer, the thermal image may be segmented to include discrete reporting segments for each spray nozzle 54 and spray cone 58, as well as other components of interest as would be understood by those of skill in the art.

The computer 100, in various implementations, may receive the information from the thermal imaging camera 60 and use the information to formulate expected operational temperatures of various components. That is, the system 10 may include a log or other structure to record the expected baseline or normal operating temperature of each discrete section, part, or the line. In some implementations, the expected baseline or normal operating temperature is inputted by a user, determined automatically by the system 10 at the beginning of the operations, determined based on historical data, determined based on historical and real-time data using machine learning model or other algorithm.

Still in FIG. 3, in various implementations, the computer 100 may detect areas that are typically colder or hotter than their surroundings during normal operation (e.g. such as the spray cones 58 are expected to be cooler than the ambient temperature during normal operation). That is, the system 10 may determine an ambient temperature and compare the measured temperatures of the discrete segments/parts to the ambient temperature and determine where a difference is expected. Deviation from the expected difference in operating temperature and actual temperature may be indicative of an adverse condition.

In further implementations, the system 10 and computer are configured to compare detected temperatures to the baseline/expected temperature and determine if there is a deviation between the actual and baseline/expected temperature. Deviation from the baseline/expected temperature may be indicative of an adverse condition.

The computer 100, in some implementations, may be in electronic communication with a notification system 110. The notification system 110 may be constructed to receive information from the computer 100 and output it to a user, optionally via a display 14. The notification system 110 may be integrated with or otherwise in communication with various display devices, such as a computer monitor, heads-up display, digital readout, or a device configured to send electronic information or notifications to an external device, such as a tablet, smartphone, or laptop.

In some implementations, the computer 100 may send a notification through the notification system 110 to inform the user of the system 10 status. For example, if the system detects a difference between the expected temperature of an area (part or discrete area) and the measured temperature of the area (part or discrete area) the notification system 110 may alert a user of the difference and the suspected condition it may identify. In various implementations, the notification system 110 may only inform a user and/or log the deviation if the deviation is more than a threshold value. The threshold value for deviation may be user inputted, determined by the system 10 using historic data, and/or determined using a machine learning model or like algorithm.

In various implementations, the system 10 may only determine that an adverse condition is occurring if there is a deviation from baseline/expected temperature for more than a threshold period of time/distance. Such threshold period of time or distance may be user inputted, determined by the system 10 using historic data, and/or determined using a machine learning model or like algorithm.

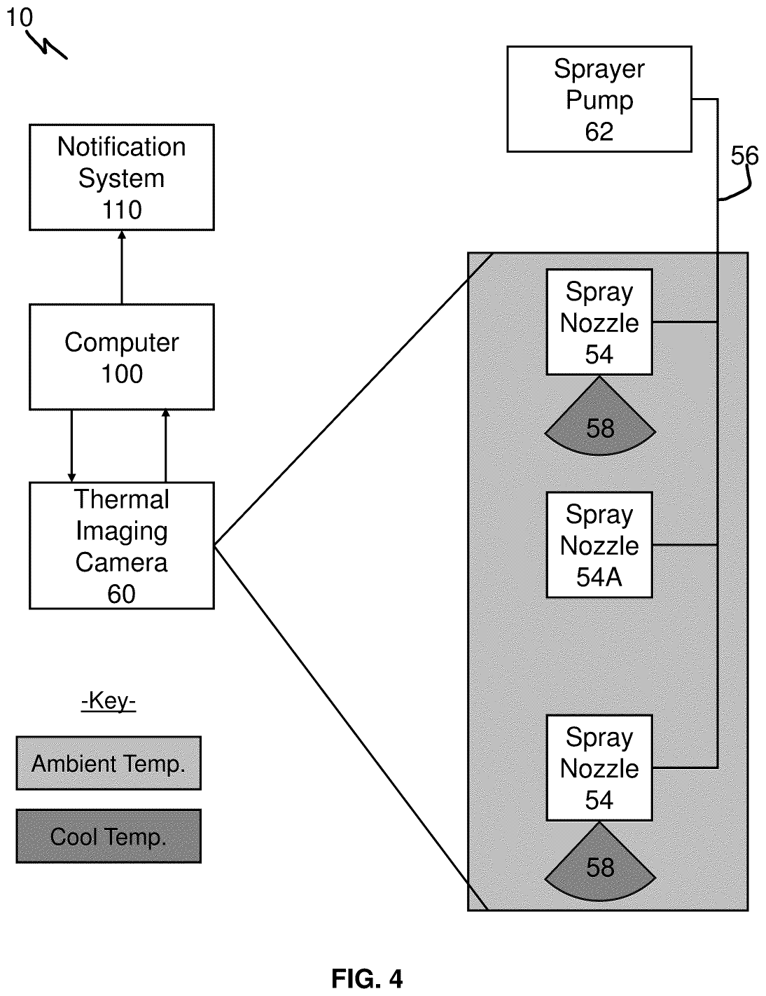

In one specific use-case, such as shown in FIG. 4, if a spray nozzle 54 becomes plugged, in a system 10 where the fluid experiences evaporative cooling when exiting the spray nozzle 54, the plugged spray nozzle 54A will no longer create a spray cone 58. As would be understood, if a spray cone 58 of fluid no longer exists, the temperature of that area will no longer experience evaporative cooling and the temperature of that area will return to ambient temperature. In this case, the computer 100 the expected temperature of the spray cone below the plugged nozzle is below ambient temperature, and because the real measured temperature of the area identified to be the spray cone of the plugged nozzle 54A is at or near ambient temperature and adverse condition has been detected. The adverse condition can be reported to a user, such as by a notification pop-up showing the a clogged spray nozzle 54A, various alternative methods for notification are possible and would be understood by those of skill in the art.

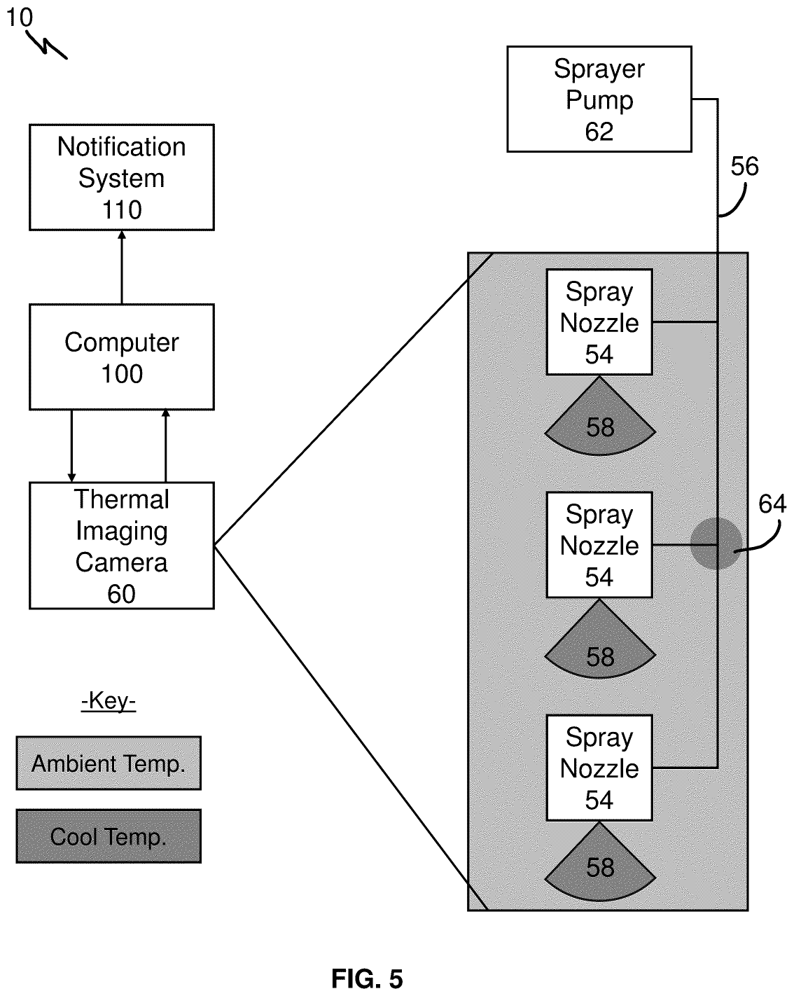

Turning now to FIG. 5, in various implementations, the thermal imaging camera 60 may image the various hoses 54 between the sprayer pump 62. As would be understood, the various fittings and seals of the hoses 56 may spring a leak 64, which may allow fluid to evaporate or vaporize through the leak 64 into the surrounding environment. This evaporation or vaporization may cause a decrease in the temperature in the area around the leak 64. In this example, the computer 100 expects the temperature of the hoses 56 and the surrounding environment to be about ambient temperature. In the scenarios where there is a leak 64, the decrease in temperature of the area of the leak 64 can be detected by the computer 100. If the decrease in temperature exceeds a threshold difference then the system 10 may register that there is a leak 64 and optionally send a notification through the notification system 110 to the user. In various further implementations, the system 10 may take corrective action upon detection of the leak 64 including shutting off the sprayer, closing one or more valves near the leak to prevent further leakage, or other corrective action as would be understood.

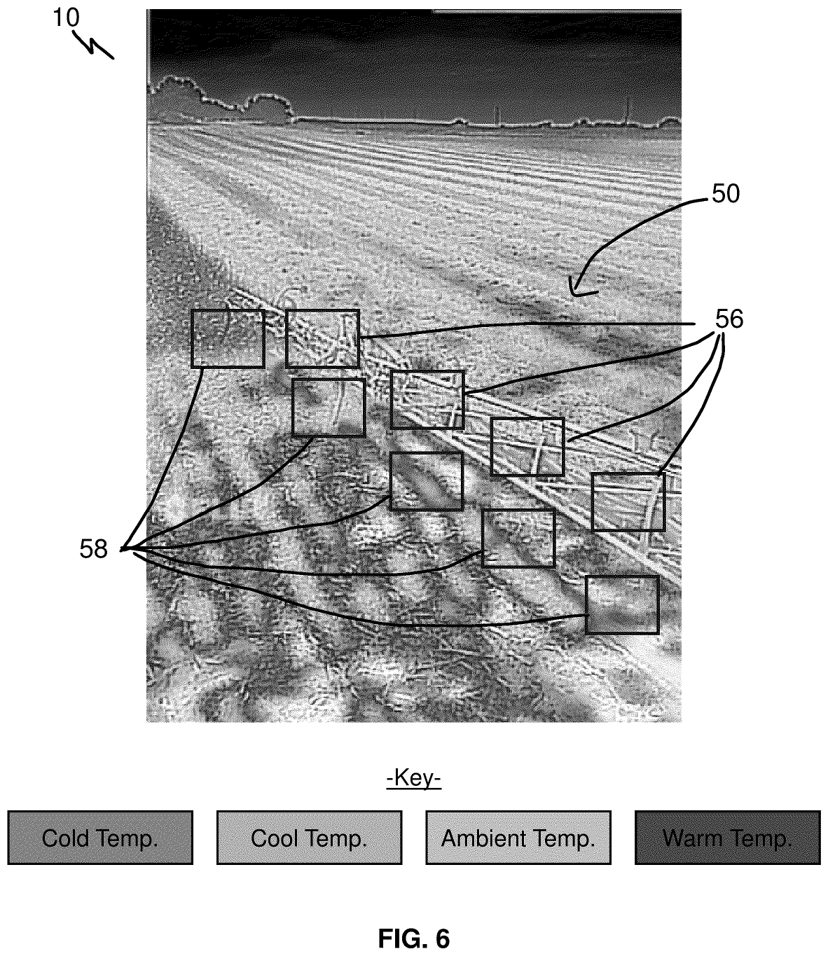

FIG. 6 shows an exemplary thermal image taken by a thermal imaging camera 60. In this example the thermal imaging camera 32 is viewing a sprayer 50 and the system 100 processed the image to detect plugged spray nozzles 54, as discussed above. Shown are various examples of discrete segments for each spray cone 58 and various segments for the hoses 56. Various alternative segmenting is possible and would be understood by those of skill in the art.

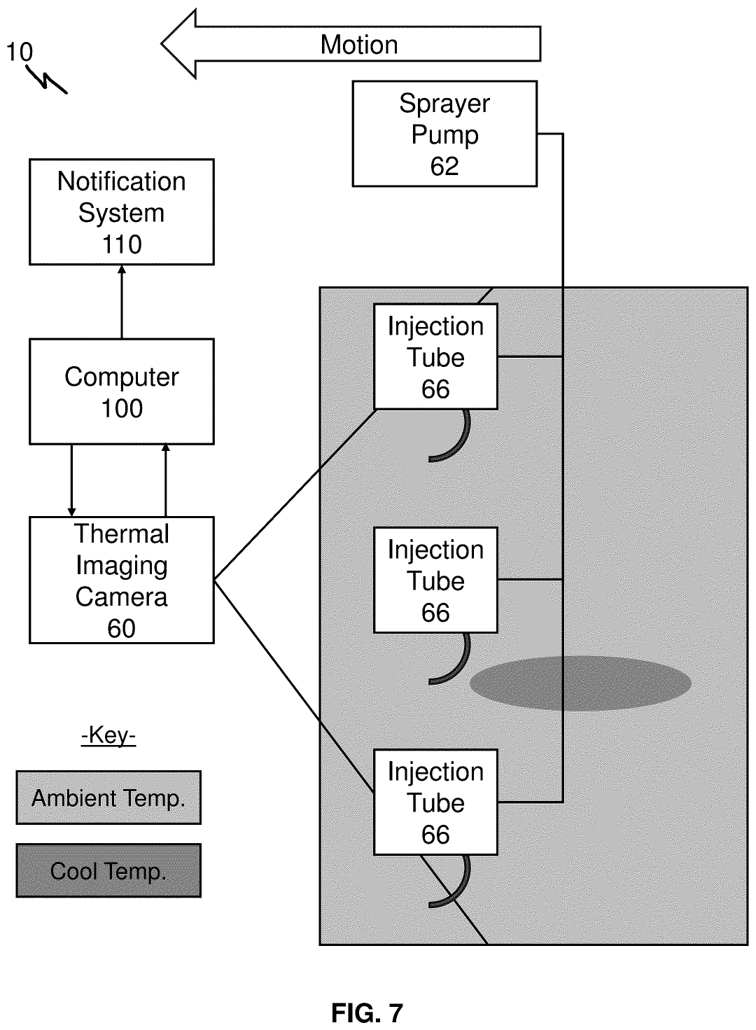

Turning now to FIG. 7, in some implementations, the thermal imaging camera 60 may be oriented to capture both relevant equipment as well as the surrounding ground/area. In various implementations, this thermal imaging camera 60 orientation may be used on a system 10 that includes injection tubes 66. As would be understood, injection tubes 66 are pieces of equipment constructed to pierce the ground and inject a fluid directly into the soil. In various implementations, the fluid may be anhydrous ammonia or other solutions as would be understood. As would be understood, anhydrous ammonia is volatile and hazardous, so direct injection into the soil may prevent waste and exposure to users.

As would be known to those in the art, if the injection tubes 66 do not sufficiently penetrate the soil, the injected fluid may be too close to the surface and may be able escape the soil by volatilizing into the air. This volatilization may cause a decrease in temperature in the soil and air above the soil, that is a decrease in temperature would be view in the area of the fluid leaking from the soil. Various implementations of the system 10 may be designed to detect resulting decrease in temperature resulting from the fluid leaking from the soil and may alert the user so the user may manually adjust the penetration depth of the injection tubes 66, reschedule fertilizing for a time with better soil conditions, and/or take other remedial actions known to those in the art. In various further implementations, the system 10 may automatically or semi-automatically take corrective action including adjusting the penetration depth of the injection tubes 66, stopping and restarting fertilizing at a time with better soil conditions, turning off the injection tube of interest optionally by closing one more valves, or other remediation measures appreciated by those of skill in the art.

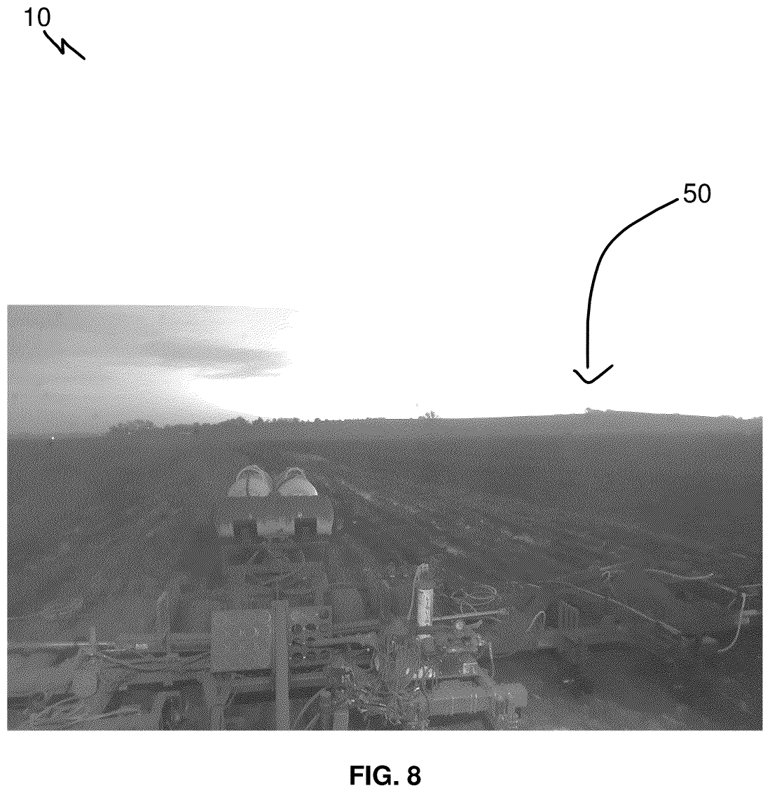

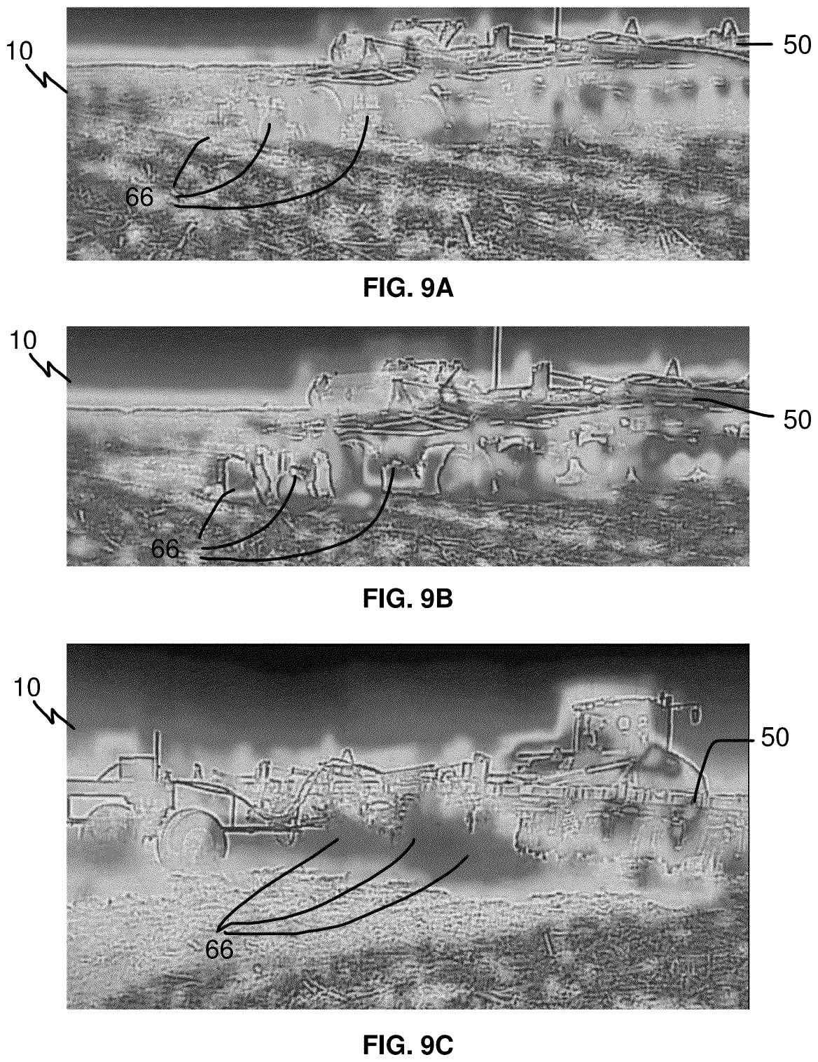

FIGS. 8 and 9A-C show exemplary images, where anhydrous ammonia is escaping the soil. FIG. 8 shows a standard RBG image of an anhydrous ammonia application where the fluid is not being property applied and escaping soil. Using such a traditional camera the vapor is difficult detect due to factors such as dust, fog, poor lighting, and others.

FIG. 9A shows a scenario where little or no ammonia is escaping the soil, so the soil and surrounding air is approximately at ambient temperature. FIG. 9B shows a scenario where a moderate amount of ammonia is escaping the soil, which results in cooler segments near/behind the injection tubes 66. FIG. 9C shows a scenario where a significant amount of ammonia is escaping the soil, which results in large cooler areas near/behind the injection tubes 66. As can be seen by comparing FIG. 8 with FIGS. 9A-C, the use of the thermal imaging camera 60 provides an improved method of detecting ammonia escape compared to visual inspection.

In various implementations, the system 10 may be used to detect or predict maintenance issues. As would be understood, many parts of agricultural equipment experience friction, fatigue, and wear, which must be remedied through actions like lubrication, wear part replacement, or other techniques known to those in the art. There are numerous pieces of agricultural equipment on which the system 10 may be used to detect or predict maintenance issues.

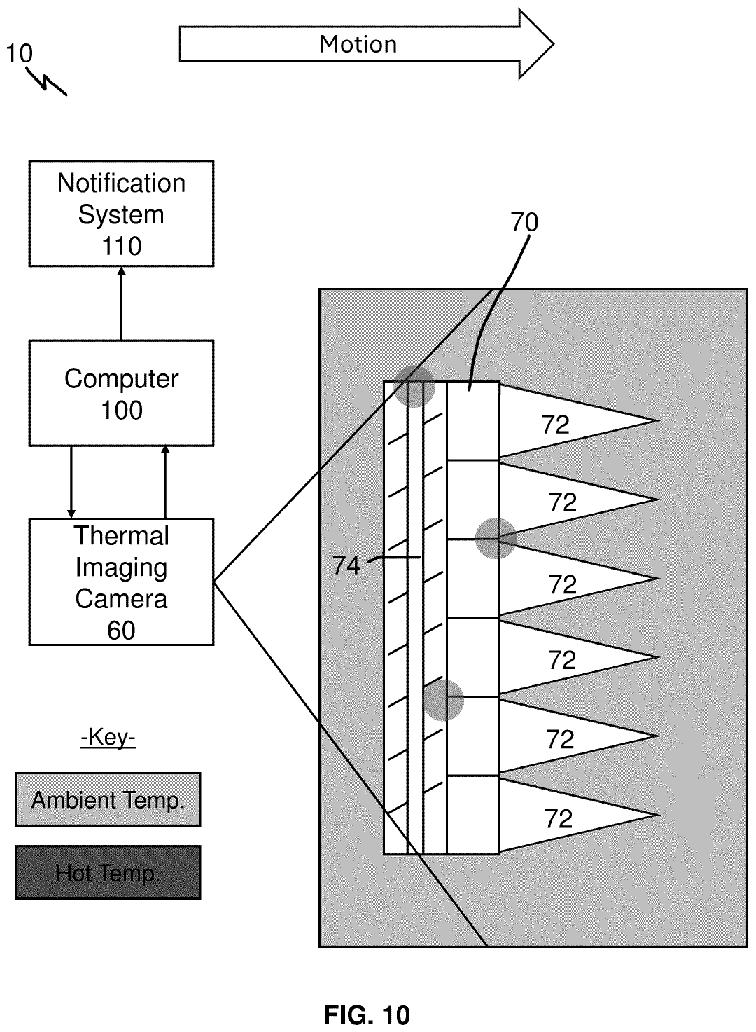

FIG. 10 shows a diagram of an exemplary implementation of the system 10 where the system 10 is used on a header 70, such as a corn header, of a combine harvester. In various implementations, the header 70 may consist of several deck plates 72 that direct corn from the stalk to an auger 74, which directs the corn further into the harvester, as would be generally understood. As would be understood, the moving components of the deck plates 72 and auger 74 may experience many conditions that cause wear and friction. For instance, the auger 74 may rub against plant material pressed between the auger 74 flights and its trough. Or the plant material may flex the auger 74 sufficiently to cause the auger 74 flights to rub on the auger 74 trough directly. As the auger 74 rotates, its bearings may wear out the lubricant within the bearings. And as the chains of the deck plate 72 cycle, they may lose their lubrication and rub against nearby surfaces. All of these potential conditions and more are likely to generate heat, generally through friction, above the heat generated in normal operating conditions. As would be understood, this heat may cause a significant increase in the surface temperature of the chains, flights, bearings, and other components of the header 70.

In these and other implementations, the thermal imagining camera 60 may be oriented to view the relevant components of some equipment, such as the header 70 of a combine harvester. The thermal imaging camera 60 and computer 100 may then compare the measured temperatures of the components of the header 70 to temperatures measured during normal operation (i.e. the expected/baseline temperature). If components with temperatures more than a threshold amount above the expected/baseline temperature of normal operation are measured, the computer 100 may send notice to the user through the notification system 110 that a component needs maintenance attention. In various further implementations, the system 10 may automatically or semi-automatically take corrective action such as by shutting off the header 70, running a clearing cycle to remove debris, or other remedial action as would be understood.

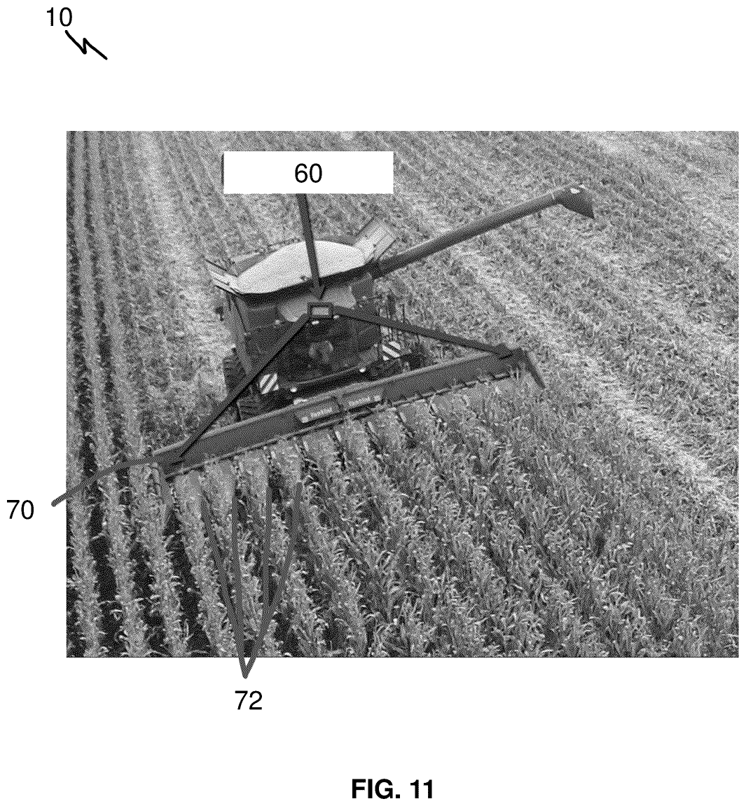

FIG. 11 shows one mounting position of the thermal imaging camera 60 on a combine harvester to view a corn header 70. Various alternative mounting positions are possible and would be understood by those of skill in the art.

In the various implementations of the system 10, various methods may be employed in determining the baseline temperature of various components and in determining whether a variation from the baseline temperature is sufficient to trigger a notification. Baseline temperatures may be computed using a rolling average, a user-input temperature, an ambient temperature from a separate thermometer, or any other method that would be considered equivalent to those in the art. Determining if a temperature variation away from baseline is sufficient to trigger a notification may be user-determined by inputting percentage thresholds or absolute temperature thresholds. In various implementations, the baseline temperature and temperature variations may also be determined using artificial intelligence, machine learning, or similar technologies to model and predict whether certain measurements are within baseline tolerances or constitute a sufficient variation to trigger a notification.

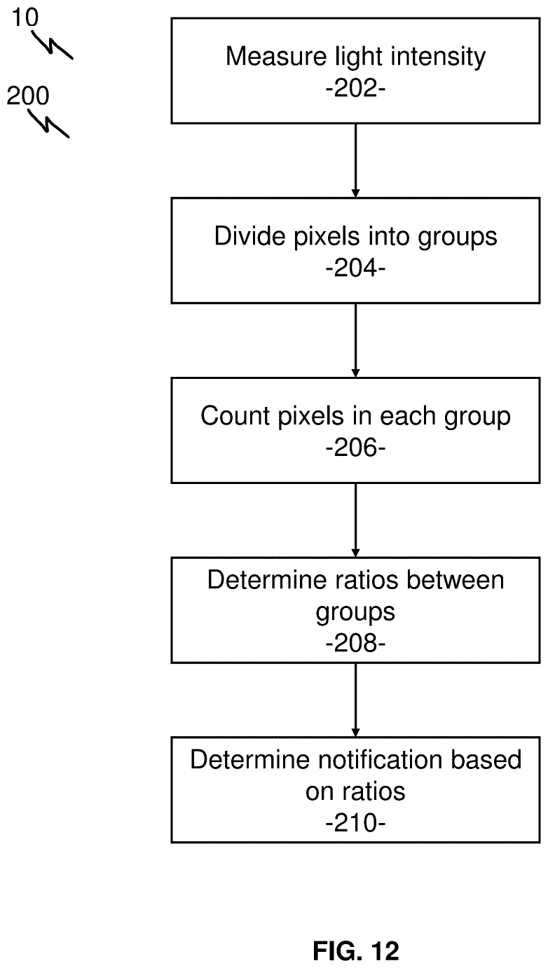

In some implementations, the thermal imaging camera 60 and computer 100 may follow a protocol to filter the light information being measured. FIG. 12 shows a method 200, according to some implementations, of determining whether the measured infrared light signals indicate a condition that justifies notifying the user or taking automatic remedial action.

Each step in the method 200 is optional and may or may not be performed, as desired for any particular implementation. Additionally, the order of the steps of the method 200 given is illustrative and is not limiting. The steps of the method 200 may be performed, or not, in any order regardless of the order they happen to be presently disclosed in.

The method 200, in various implementations, each the thermal imaging camera 60 intakes light coming from the target area and quantifies the intensity of the light (box 202), optionally on a pixel by pixel level. The thermal imaging camera 60 or the computer 100 may then divide the pixels into groups, depending on their light intensity (box 204). In various implementations, the groups may be dark, medium, and light, where dark indicates the least light intensity, light indicates the most light intensity, and medium exists in the middle. Of course, various other group configurations are possible. The thermal imaging camera 60 or computer 100 may then determine the number of pixels in each group (box 206) and calculate the ratios of the number of pixels between the different groups (box 208). Once the ratios are determined, the computer 60 may determine if the ratios correspond to an adverse event/condition that justifies notifying the user (box 210). In various implementations, some ratios may correspond to a no-vapor condition, a slight-vapor condition, or a heavy-vapor condition, such as in implementations where the ground is being monitored for anhydrous ammonia vapor, or similar fluid, escaping the ground.

Although the disclosure has been described with references to various embodiments, persons skilled in the art will recognize that changes may be made in form and detail without departing from the spirit and scope of this disclosure.

What is claimed is:

1. An agricultural equipment monitoring system, comprising:
(a) a thermal imaging camera oriented to monitor some or all of the agricultural equipment; and
(b) a computer in electronic communication with the thermal imaging camera,
wherein the thermal imaging camera and computer detect changes in temperature.

2. The system of claim 1, further comprising a notification system configured to notify a user of an adverse condition, wherein the notification system is in electronic communication with the computer.

3. The system of claim 2, wherein the presence of an adverse condition is determined by a change in temperature.

4. The system of claim 3, wherein the agricultural equipment comprises one or more spray nozzles.

5. The system of claim 4, wherein the adverse condition is a clog indicated by a lack of one or more spray cones emanating from the one or more spray nozzles.

6. The system of claim 4, wherein the adverse condition is a leak indicated by a cold environment around a hose leading to the one or more spray nozzles.

7. The system of claim 3, wherein the agricultural equipment comprises one or more injection tubes.

8. The system of claim 7, wherein the adverse condition is vaporization of an injected fluid indicated by a cold environment trailing the one or more injection tubes.

9. The system of claim 7, wherein the adverse condition is a leak indicated by a cold environment around a hose leading to the one or more injection tubes.

10. The system of claim 3, wherein the adverse condition is a maintenance issue indicated by a hot environment around a component.

11. A method of identifying an adverse condition in agricultural equipment, comprising:
measuring temperatures in a field of view with a thermal imaging camera;
determining if the measured temperatures indicate an adverse condition; and
notifying a user of the adverse condition.

12. The method of claim 11, wherein one or more spray nozzles and hoses are in the field of view and the hoses connect the one or more spray nozzles to a sprayer pump.

13. The method of claim 12, wherein the adverse condition is a clog indicated by the lack of one or more spray cones emanating from the one or more spray nozzles.

14. The method of claim 12, wherein the adverse condition is a leak indicated by a cold environment around a hose leading to the one or more spray nozzles.

15. The method of claim 11, wherein one or more injection tubes and hoses are in the field of view and the hoses connect the one or more spray nozzles to a sprayer pump.

16. The method of claim 15, wherein the adverse condition is vaporization of an injected fluid indicated by a cold environment trailing the one or more injection tubes.

17. The method of claim 15, wherein the adverse condition is a leak indicated by a cold environment around a hose leading to the one or more injection tubes.

18. The method of claim 11, wherein the adverse condition is a maintenance issue indicated by a hot environment around a component.

19. The method of claim 11, wherein the adverse condition is a maintenance issue indicated by a hot environment around a component.

20. An equipment monitoring system, comprising:
(a) a thermal imaging camera configured to measure temperatures;
(b) a computer in electronic communication with the thermal imaging camera and configured to detect changes in temperature; and
(c) a notification system in electronic communication with the computer,
wherein the thermal imaging camera transmits the temperatures to the computer and the computer instructs the notification system to notify a user if a change in temperature occurs.
